(19) United States
(12) Patent Application Publication
(10) Pub. No.: US 2026/0222221 A1
(43) Pub. Date: Jul. 30, 2026

(54) ACCESS CONTROL

(71) Applicant: KONE Corporation, Helsinki (FI)

(72) Inventors: Mohit Sethi, Helsinki (FI); Mika Katara, Helsinki (FI)

(73) Assignee: KONE Corporation, Helsinki (FI)

(21) Appl. No.: 19/578,423

(22) Filed: Mar. 25, 2026

Related U.S. Application Data
(63) Continuation of application No. PCT/EP2023/076361, filed on Sep. 25, 2023.

(51) Int. Cl. H04L 9/32

(52) U.S. Cl. CPC H04L 9/3242; H04L 9/3247

(57) ABSTRACT

According to an example embodiment, a system (100) is provided, the system (100) comprising a server arrangement (110) and target system (120), wherein the server arrangement (110) is configured to receive an access code request to provide an access code for accessing at least a portion of the target system (120), wherein the access code request is associated with the target system, and determine, in response to said access code request, the access code via usage of a predefined cryptographic procedure based at least on information stored at the server arrangement (110); and wherein the target system (120) is configured to receive an access request for accessing the target system (120), wherein the access request comprises said access code determined at the server arrangement (110), verify, in response to said access request, the access code included in said access request via usage of said predefined cryptographic procedure based at least on information stored at the target system (120), which information corresponds to said information stored at the server arrangement (110), and grant access to said at least portion of the target system (120) based on successful verification of the access code received in the access request.

### TECHNICAL FIELD

The present invention relates controlling access by an apparatus to a target system.

### BACKGROUND

Various electrical and electromechanical equipment may be controlled via user interfaces (UIs) provided via control apparatuses that are integrated to the equipment or via control apparatuses that may be communicatively coupled to the equipment, where the UI may enable operating and/or configuring certain functions of the underlying equipment.

In many scenarios, unauthorized access for operating or configuring the equipment may pose a serious risk to security and integrity of the underlying equipment and therefore access to the equipment in terms of operating and/or configuring the equipment is strictly limited to authorized persons only, e.g. persons authorized to operate the equipment and/or to persons authorized to carry out configuration and/or maintenance operations to the equipment. Consequently, access to operate or configure the equipment via the UI may require authentication and/or authorization to ensure that only authorized persons have access to the equipment, where authentication and/or authorization may further account for the user's access level in operating or configuring the equipment.

Non-limiting examples of equipment that enable at least some extent of control via such UIs include passenger conveyor systems, such as elevator systems, escalator systems, turnstiles or supporting systems thereof. In such systems, possible unauthorized access via the UI for operating a component of a passenger conveyor system or, in particular, for configuring operation of a component the passenger conveyor system would quite obviously provide a serious threat to safe operation and integrity of the passenger conveyor system and such unauthorized access should be strictly prohibited.

Access control mechanisms applied for controlling access to equipment via such UIs typically employ authentication and/or authorization schemes known in the art, which typically rely on cryptographic methods that provide strong authentication (e.g. multi-factor authentication) While such authentication and authorization mechanisms are well-established and provide a well-working mechanism for such purposes, they nevertheless require constant network connectivity between an access control entity associated with the equipment and an authentication/authorization server and lack flexibility for supporting use-cases where multiple users are required to input their respective credentials in specific order in order to complete actions that require authentication and/or authorization.

### SUMMARY

It is an object of the present invention to provide an access control technique that involves a reduced system complexity and improved flexibility without compromising security.

According to an example embodiment, a method for controlling access to a target system is provided, the method comprising: receiving, at a server arrangement, an access code request to provide an access code for accessing at least a portion of the target system, wherein the access code request is associated with the target system; determining, at the server arrangement in response to said access code request, the access code via usage of a predefined cryptographic procedure based at least on information stored at the server arrangement; receiving, at the target system, an access request for accessing the target system, wherein the access request comprises said access code determined at the server arrangement; verifying, at the target system in response to said access request, the access code included in said access request via usage of said predefined cryptographic procedure based at least on information stored at the target system, which information corresponds to said information stored at the server arrangement; and granting, by the target system, access to said at least portion of the target system based on successful verification of the access code received in the access request.

According to another example embodiment, a system is provided, the system comprising a server arrangement and target system, wherein the server arrangement is configured to receive an access code request to provide an access code for accessing at least a portion of the target system, wherein the access code request is associated with the target system, and determine, in response to said access code request, the access code via usage of a predefined cryptographic procedure based at least on information stored at the server arrangement; and wherein the target system is configured to receive an access request for accessing the target system, wherein the access request comprises said access code determined at the server arrangement, verify, in response to said access request, the access code included in said access request via usage of said predefined cryptographic procedure based at least on information stored at the target system, which information corresponds to said information stored at the server arrangement, and grant access to said at least portion of the target system based on successful verification of the access code received in the access request.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

Some features of the invention are set forth in the appended claims. Aspects of the invention, however, both as to its construction and its method of operation, together with additional objects and advantages thereof, will be best understood from the following description of some example embodiments when read in connection with the accompanying drawings.

### BRIEF DESCRIPTION OF FIGURES

The embodiments of the invention are illustrated by way of example, and not by way of limitation, in the figures of the accompanying drawings, where

FIG. 1 illustrates a block diagram of some elements of an access control system according to an example;

FIG. 2 illustrates a block diagram of some elements of an access control system according to an example;

FIG. 3 illustrates a method according to an example; and

FIG. 4 illustrates a block diagram of some elements of an apparatus according to an example.

### DESCRIPTION OF SOME EMBODIMENTS

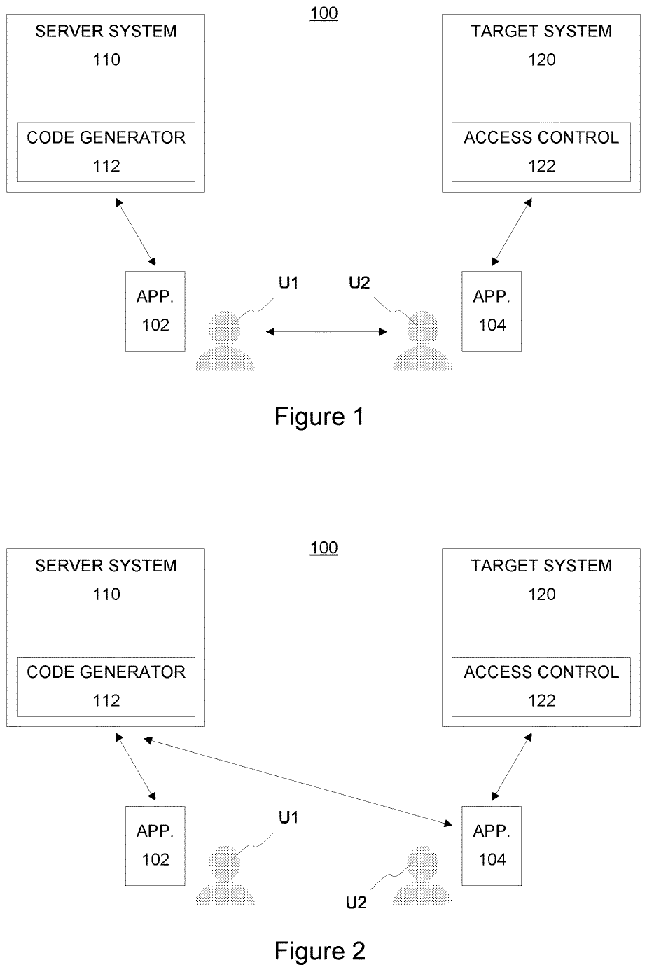

FIGS. 1 and 2 illustrate respective block diagrams of some components of a system 100 according to an example. The system 100 as illustrated in the respective examples of FIGS. 1 and 2 includes a first apparatus 102, a second apparatus 104, a server arrangement 110, and a target system 120. The first apparatus 102 may be operated by a first user U1 and the second apparatus 104 may be operated by a second user U2. The server arrangement 110 may comprise a code generator portion 112 for determining access codes for accessing the target system 120 or one or more portions thereof based on requests issued by the first user U1 via the first apparatus 102, whereas the target system 120 may comprise an access control portion 122 for carrying out the access control for the target system 120 via verifying the access codes provided by the second user U2 via the second apparatus 104 upon an attempt to access the target system 120 or one or more portions thereof. Hence, the code generator portion 112 of the server arrangement 110 and the access control portion 122 of the target system 120 may be considered to constitute an access control system or an identification system for controlling access to at least a portion of the target system 120.

The access code may be also referred to as an access token or a token, whereas in the following examples predominantly apply the term access code. The target system 120 or part thereof may be also referred to as an equipment under control (EUC), whereas the following examples predominantly apply the term target system. In an exemplifying usage scenario of the system 100, the second user U2 may be positioned in close proximity of the target system 120 and the first user U1 may be positioned at a location that is remote from the target system 120, whereas in other exemplifying usage scenarios both the second user U2 and the first user U1 may be positioned in close proximity of the target system 120 or both the second user U2 and the first user U1 may be positioned at respective locations that are remote from the target system 120.

The first apparatus 102 may be assigned a first device identifier (ID), the second apparatus 104 may be assigned a second device ID, the first user U1 may be assigned a first user ID, and the second user U2 may be assigned a second user ID. The target system 120 may be assigned a target system identifier, which allows e.g. the code generator portion 112 to identify the target system 120 for which the access code is to be generated. Moreover, there may be also one or more portion IDs for the target system 120, each assigned to a certain portion of the target system 120, where a given portion of the target system 120 may comprise a certain component, interface, service, or function of the target system 120.

In a non-limiting example, an access code associated with the target system ID in general may provide access to the target system 120 in its entirety, e.g. to all components, interfaces, services and/or functions available in the target system 120, whereas in another example a first access code associated with a first portion ID for the target system 120 may provide access to a first portion of the target system 120 and a second access code associated with a second portion ID for the target system 120 may provide access to a second portion of the target system 120. In this regard, the first portion of the target system 120 may comprise an interface to functions related to normal operation of the target system 120 under control of an operator of the target system (serving as the second user U2), whereas the second portion of the target system 120 may comprise an interface to functions related to configuration and/or adjustment of functionality of the target system 120 via actions carried out by a maintenance person (serving as the second user U2).

While the access control system according to the present disclosure is applicable for controlling access to target systems of various kinds, in a non-limiting particular example, the target system 120 may comprise a passenger conveyor system such as an elevator system or an escalator system. In this regard, access control system formed by the code generator portion 112 and the access control portion 122 may be applied to control access to a control system of the passenger conveyor system, which control system enables operating and/or configuring respective operation of various components of the passenger conveyor system or supporting systems operated in conjunction with the passenger conveyor system. Following up the generic example outlined above, the access control system may be applied to separately control access to different interfaces for accessing the control system of the passenger conveyor system, e.g. first ones that enable an operator of the passenger conveyor system to access functions related to normal operation of the passenger conveyor system or a supporting system thereof and second ones that enable a maintenance person to access functions related to configuration and/or adjustment of functionalities of the passenger conveyor system or a supporting system thereof.

The system 100 illustrated in the examples of FIGS. 1 and 2 and outlined in the foregoing refers to the first user U1 using the first apparatus 102 to request the code generator portion 112 of the server arrangement 110 to determine the access code, which is applicable for the second user U2 accessing the target system 120 via using the second apparatus 104, where the second apparatus 104 may acquire the access code via the first apparatus 102 or the second apparatus 104 may retrieve the access code from the server arrangement 110. In a variation of this example, the first user U1 may use the first apparatus 102 to request the access code from the server arrangement 110 for the purpose of the first user U1 using the first apparatus 102 to access the target system 120. In general, in some scenarios the access code may be determined in response to a request from one apparatus whereas the access may be applied to access the target system 120 from another apparatus, whereas in other scenarios the request to determine the access code may be received from the same apparatus that will be subsequently applied to access the target system 120. Moreover, in some scenarios the request to determine the access code may originate from a same user who will subsequently use the access code to access the target system 120, whereas in other scenarios the access code may be determined based on request from a first user to subsequently enable a second user to access the target system 120.

In a further example, the code generator portion 112 of the server arrangement 110 may be applied to determine a sequence of two access codes including a first access code and a second access code, where the first access code is determined for the first user U1 and the second access code is determined for the second user U2 and where the first user U1 may apply the first access code to access the target system 120 (via using the first apparatus 102 or the second apparatus 104) to carry out a first part of an operation pertaining to the target system 120 and the second user U2 may apply the second access code to access the target system 120 (via using the first apparatus 102 or the second apparatus 104) to carry out a second part of the operation pertaining to the target system 120. As an example in this regard, the operation may comprise installation of a software update to the target system 110, where the first user U1 may initiate the software update by using the first apparatus 102 to apply the first access code at a location that is remote from the target system 120 (and connected to the target system 120 via a communication network) and the second user U2 may subsequently complete the installation of the software update by using the second apparatus 104 to apply the second access code at a location that is close proximity of the target system 120 (and connected to the target 120 system e.g. via local area communication network or communication link). In a variation of this example, the order of determining and applying the first and second access codes is reversed, leading to a scenario where the second user U2 may apply the second access code to carry out the first part of the operation pertaining to the target system 120 (e.g. initiate installation of the software update at a location that is close proximity of the target system 120) and the first user U1 may apply the first access code to carry out the second part of the operation pertaining to the target system 120 (e.g. complete the installation of the software update at a location that remote from the target system 120).

The first apparatus 102 may be also referred to as a first user apparatus 102. In various examples, the first apparatus 102 may be embodied as a computer apparatus that may be communicatively coupled to the server arrangement 110 e.g. via a communication network (such as the Internet), e.g. general-purpose computer apparatus such as a mobile phone, a tablet computer, a laptop computer, a desktop computer, etc. executing a first client software application that enables (e.g. via a user interface (UI) provided by the first software application) requesting the access code from the server arrangement 110. In this regard, the computer apparatus that serves to embody the first apparatus 102 may comprise one or more processors and one or more memories storing one or more computer programs, where the one or more processors are arranged to execute the one or more computer programs to cause the computer apparatus to operate as the first apparatus 102 according to the present disclosure.

The second apparatus 104 may be also referred to as a second user apparatus 104. In various examples, the second apparatus 104 may be embodied as a computer apparatus that may be communicatively coupled to the access control portion 122 of the target system 120 e.g. via a communication link or via a communication network (such as a local area network (LAN)), e.g. general-purpose computer apparatus such as a mobile phone, a tablet computer, a laptop computer, a desktop computer, etc. executing a second client software application that enables entering the access code and/or operating at least a portion of services and/or functions available in the target system 120 e.g. via a UI provided by the second software application. In other examples, the second apparatus 104 may be embodied as a dedicated control apparatus, which may be provided as a computer apparatus that is dedicated for controlling services and/or functions available in the target system 120 and that provides a UI that may enable e.g. entering the access code and/or operating at least a portion of services and/or functions available in the target system 120. In various examples, the dedicated control apparatus may be communicatively coupled to the access control portion 122 of the target system 120 e.g. via a communication link or via a communication network or the dedicated control apparatus may be integrated to an apparatus that serves to embody at least a portion of the target system 120 (e.g. the access control portion 122). Along the lines described above for the first apparatus 102, the computer apparatus that serves to embody the second apparatus 104 may comprise one or more processors and one or more memories storing one or more computer programs, where the one or more processors are arranged to execute the one or more computer programs to cause the computer apparatus to operate as the second apparatus 104 according to the present disclosure.

In various examples, the server arrangement 110 may comprise one or more computer apparatuses that are arranged to implement one or more functionalities provided by the server arrangement 110. Along the lines described above for the first and second apparatuses 102, 104, each computer apparatus involved may comprise respective one or more processors and respective one or more memories storing respective one or more computer programs, execution of which by the respective one or more processors of the respective computer apparatus causes the respective computer apparatus to implement its share of the one or more functionalities provided by the server arrangement. In a particular example, the one or more computer apparatuses may be arranged to provide a cloud computing service that is configured to implement the one or more functionalities provided the server arrangement 110. The target system 120 may, likewise, comprise one or more computer apparatuses that are arranged to implement one or more functionalities provided by the target system 120, where each of the one or more computer apparatuses applied to implement the target system 120 may be of the kind described above for computer apparatuses applied for providing the server arrangement 110.

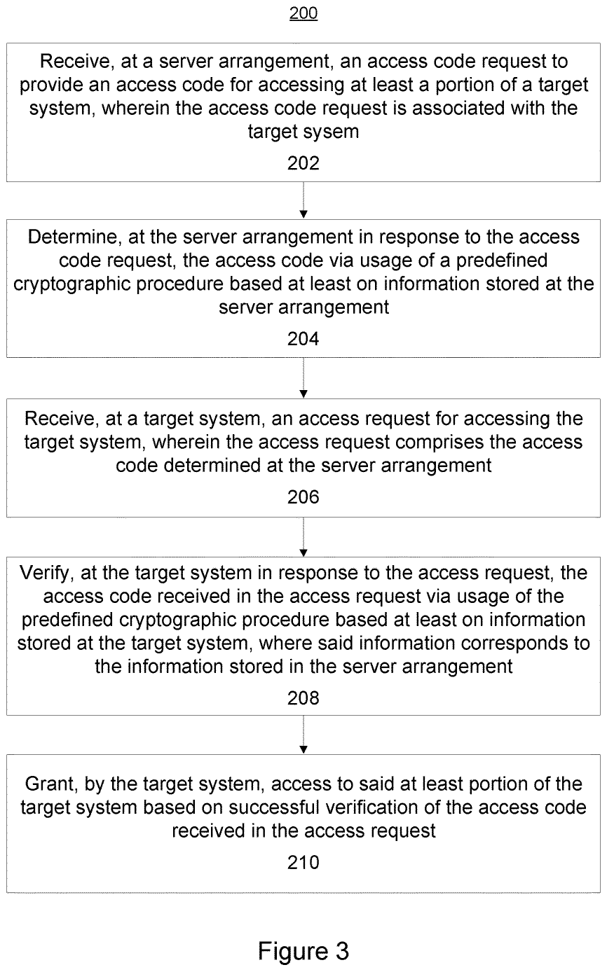

One of the functionalities implemented by the server arrangement may be the code generator portion 112 described in the foregoing and in the following, whereas one of the functionalities implemented by the target system 120 may be the access control portion 122 described in the foregoing and in the following. Along the lines described in the foregoing, the code generator portion 112 of the server arrangement 110 and the access control portion 122 of the target system 120 may be considered to constitute an access control system or an identification system for controlling access to at least a portion of services or functions available via the target system 120. In a non-limiting example, the code generator portion 112 and the access control portion 122 may be considered to provide the access control system or the identification system via jointly implementing a method 200 illustrated in FIG. 3. The method 200 serves to control access to the target system 120 via carrying out the following steps:
receiving, at the server arrangement 110, an access code request to provide an access code for accessing at least a portion of the target system 120, wherein the access code request is associate with the target system 120 (block 202),
determining, at the server arrangement 110 in response to the access code request, the access code via usage of a predefined cryptographic procedure based at least on information securely stored at the server arrangement 110 (block 204),
receiving, at the target system 120, an access request for accessing the target system 120, wherein the access request comprises the access code determined at the server arrangement 110 (block 206),
verifying, at the target system 120 in response to the access request, the access code included in the access request via usage of the predefined cryptographic procedure based at least on information stored at the target system 120, where said information corresponds to the information stored at the server arrangement 110 (block 208), and
granting by the target system 120, access to said at least portion of the target system 120 based on successful verification of the access code received in the access request (block 210).

The method 200 may be complemented or modified in a number of ways, for example in accordance with examples described in the foregoing and/or in the following. For clarity and brevity of description, in the following examples it is assumed that the access code request originates from the first apparatus 102, whereas the access request for accessing the target system 120 via usage of the access code originates from the second apparatus 104. Nevertheless, along the lines described in the foregoing, in various examples the access code request may originate from the second apparatus 104 instead of the first apparatus 102 and/or the access request for accessing the target system 120 may originate from the first apparatus 102 instead of the second apparatus 104.

Referring back to the access code request (cf. block 202), in one example the access code request is associated with a specific target system, whereas in another example the access code request is associated with a plurality of target systems of a certain type. As examples of the latter, the access code request may be associated with target systems operated by a certain operator, with target systems manufactured by a certain manufacturer, with target systems serving a certain purpose, etc. According to an example, the association between the access code request and the target system 120 is implicit, e.g. via the code generator portion 112 of the server arrangement 110 being dedicated for determining access codes for a specific target system or for target systems of a certain type (whichever may apply). According to another example, the access code request comprises a target ID that explicitly associates the access code request to a specific target system or to target systems of a certain type (whichever may apply), thereby making the association between the access code request and the target system 120 explicit.

The determination of the access code in the server arrangement 110 (cf. block 204) and verification of the access code in the target system 120 (cf. block 208) may be carried out using e.g. one of the following approaches, which may be considered as respective embodiments of the approach described in the present disclosure:
According to a first embodiment, determination of the access code comprises applying a hash-based message authentication code (HMAC) via application of a predefined cryptographic hash function and a predefined secret key, and verification of the access code comprises applying the HMAC with the predefined cryptographic hash function and the predefined secret key.
According to a second embodiment, determination of the access code comprises applying a predefined cryptographic hash function with a first predefined secret data, and verification of the access comprises applying the predefined cryptographic hash function with second predefined secret data that corresponds to the first predefined secret data.
According to a third embodiment, determination of the access code comprises applying a predefined authenticated encryption (AEAD) function with a predefined secret key, and verification of the of the access code comprises applying the predefined AEAD function with the predefined secret key.
According to a fourth embodiment, determination of the access comprises applying a digital signature with a predefined private key, and verification of the access comprises verifying the digital signature with a predefined public key that corresponds to the predefined private key.

Throughout the embodiments outlined in the foregoing, determination of the access code may be carried out via operation of an element of the server arrangement 110, e.g. the code generator portion 112, and verification of the access code may be carried out via operation of an element of the target system 120, e.g. the access control portion 122. In the following, various aspects of the access control system according to the present disclosure in terms of determining the access code and verifying the access code are described in the following predominantly with examples that refer to the first embodiment, whereas the aspects apart from determination of the access code in the server arrangement 110 and verification of the access code in the target system 120 are applicable in other examples as well, mutatis mutandis.

Referring back to the aspect of granting access to at least portion of the target system (120) based on successful verification of the access code received in the access request (cf. block 210), according to an example, the access may be granted (directly) in response to successful verification of the access code received in the access request. In other examples, the access to said at least portion of the target system 120 may be conditional to one or more further requirements, e.g. one or more of the following:
the access may be granted provided that the access request is received during one of one or more predefined maintenance time periods, e.g. during certain hours of a day, during certain days of a week, during certain days of month, etc.;
the access may be granted provided that the access request received when the target system 120 is one of one or more predefined operational states.

Referring now to the first embodiment, along the lines described in the foregoing, determination of the access code in the server arrangement 110 may comprise derivation of the access code using the HMAC with the predefined cryptographic hash function and the predefined secret key, whereas verification of the access code in the target system 120 may comprise applying the HMAC with the predefined cryptographic hash function and the predefined secret key that were applied for deriving the access code in the server arrangement 110. The HMAC may be derived, for example, according to a procedure described in the Request for Comments 2104 (RFC2104). In this regard, the derivation of the access code may involve using the HMAC with the predefined cryptographic hash function and the predefined secret key on a data block that includes common data, which changes with every access code request and which is known both to the server arrangement 110 and to the target system 120, whereas the verification of the access code may involve applying the HMAC with the predefined cryptographic hash function and the predefined secret key that were applied for deriving the access code in the server arrangement 110 on a data block that includes the same common data known both to the server arrangement 110 and to the target system 120. In a non-limiting example, the common data may include a sequence number that is incremented by the same amount after each access code request in the server arrangement 110 and after each successful verification in the target system 120.

Still referring to the first embodiment, the step of verifying the access code at the target system 120 may comprise deriving, at the target system 120, a verification access code using the HMAC with the predefined cryptographic hash function and the predefined secret key and comparing the verification access code to the access code received in the access request. In this regard, finding the verification access code to be identical with the access code received in the access request results in successful verification of the access code, whereas finding the verification access code to be non-identical with the access code received in the access request results in unsuccessful verification of the access code.

In the first embodiment, the predefined cryptographic hash function and the predefined secret key applied for derivation of the verification access code in the target system 120 are the same ones applied for derivation of the access code in the server arrangement 110. The predefined cryptographic hash function applied in derivation of the access code may comprise a suitable cryptographic hash function known in the art, e.g. a SHA-2 hash function such as SHA-256. The secret key applied in derivation of the access code and the verification access code serves as a shared symmetric secret between the server arrangement 110 and the target system 120. As an example, the secret key may have a size chosen from a range from 128 to 384 bits. In some examples, the secret key may be also derived from a shorter shared long-term password.

Still referring to the first embodiment, the predefined secret key in the server arrangement 110 and in the target system 120 may be set upon configuring the apparatuses applicable for determining and verifying the access code (e.g. the respective computer apparatuses applied to implement the code generator portion 112 and the access control portion 122). In this regard, each of the server arrangement 110 and the target system 120 may securely store the predefined secret key, whereas the respective secure storage of these pieces of information in the server arrangement 110 and in the target system 120 may be provided via using techniques known in the art, such as via application of a Trusted Platform Module (TPM) and/or a Trusted Execution Environment (TEE).

According to an example, the predefined secret key stored in the server arrangement 110 and the target system 120 may be changed e.g. according to a (first) predefined schedule and/or in response to a request of an administrator of the system 100 for improved long-term security of the access control system provided via joint operation of the code generator portion 112 of the server arrangement 110 and the access control portion 122 of the target system 120. The secret key may be changed e.g. via a procedure carried out over a communication network that connects each of the server arrangement 110 (e.g. the code generator portion 112) and the target system 120 (e.g. the access control portion 122) to an external resource either directly or via an intermediate device. The respective procedures between the server arrangement 110 and the external resource and between the target system 120 and the external resource for changing the secret key is preferably protected end-to-end using a technique known in the art, e.g. the Trust Anchor Management Protocol (TAMP) defined in the Request for Comments 5943 (RFC5943).

Throughout the embodiments, in some examples the access code request may comprise additional code request data including one or more information elements that further characterize the requested access. Moreover, determination of the access code (cf. block 204) may be preceded by determining, based on information elements included in the additional code request data, whether the access code request is admissible and the process may proceed to determination of the access code in response to finding the access code request admissible while the process may not proceed to determination of the access code in response to finding the access code request inadmissible. Determination of admissibility of the access code request may be carried out, for example, by the code generator portion 112 of the server arrangement 110.

In this regard, the additional code request data may include one or more of the following information elements:
one or more information elements that are descriptive of identity of an entity requesting the access code, e.g. the first device ID assigned to the first apparatus 102 and/or the first user ID assigned to the first user U1,
one or more information elements that are descriptive of identity of an entity for which the access code is requested, e.g. the second device ID assigned to the second apparatus 104 and/or the second user ID assigned to the second user U2,
one or more information elements that are descriptive of the requested access to the target system, e.g. a portion ID that, together with the target system ID, identifies a portion of the target system 120 to which the access is requested.

Consequently, in various examples, the access code request may be considered admissible provided that access code is requested by an entity that is authorized to request an access code to the target system 120 in general or to the portion of the target system 120 identified by the portion ID included in the access code request (whichever applies) and/or that the access code is requested for an entity that is authorized to access the target system 120 in general or the portion of the target system 120 identified by the portion ID included in the access code request (whichever applies). In this regard, the server arrangement 110, e.g. the code generator portion 112, may store authorization information that identifies entities authorized to request the access code to the target system 120 or to a certain portion thereof and/or entities authorized to access the target system 120 or a certain portion thereof and the authorization information may be applied in determination of admissibility or inadmissibility of the code request.

Alternatively or additionally, the determination of admissibility of the access code request may be time-dependent, e.g. such that access code requests are admissible only during predefined maintenance time periods, e.g. during certain hours of a day, during certain days of a week, during certain days of month, etc. Consequently, in some examples the access code request may be found admissible in response to receiving it during a predefined maintenance time period and it may be found inadmissible otherwise.

Throughout the embodiments, in some examples the server arrangement 110 may authenticate the first apparatus 102 and/or the first user U1 before proceeding to determination of the access code. Consequently, the method 200 may proceed to determination of the access code in response to successful authentication of the first apparatus 102 and/or the first user U1, whereas the method 200 may not proceed to determination of the access code in response to unsuccessful authentication. The authentication may be carried out using an authentication mechanism known in the art, e.g. one based on a username and a password, one based on biometric data, one based on multi-factor authentication, etc.

Throughout the embodiments, the method 200 may further comprise transferring the access code derived in the server arrangement 110 to the first apparatus 102 and/or to the second apparatus 104 to enable using the determined access code for accessing the target system 120 or a portion thereof. In some examples, the server arrangement 110 may transmit the access code determined therein to the first apparatus 102, which originally transmitted the access code request that resulted in determination of the access code. The transmission of the access code may be provided via a secure connection between the server arrangement 110 and the first apparatus 102. A security mechanism known in the art, such as inside a Transport Layer Security (TLS) tunnel, may be applied for the transfer. In case the access to the target system 120 is to be provided via the second apparatus 104, the access code received at the first apparatus 102, 104 may be input to the second apparatus 104 e.g. via an information exchange carried out under control of the first user U1 and the second user U2 (as also implied in the illustration of FIG. 1), whereas in case the first apparatus 102 is also the one that is to be used for accessing the target system 120 via usage of the access code, no further actions are necessary to enable the access. The information exchange between the first user U1 and the second user U2 may comprise, for example, a telephone call, an email, a message sent via a messaging application, etc.

In another example, the server arrangement 110 may store the access code determined therein for subsequent retrieval by the second apparatus 104 (which is a scenario implied in the illustration of FIG. 2). Consequently, the second apparatus 104 may request delivery of the access code from the server arrangement 110, which may respond to the request by transmitting the access code to the second apparatus 104. Along the lines described in the previous example, the transmission of the access code may be provided via a secure connection between the server arrangement 110 and the second apparatus 104, where a security mechanism known in the art, such as a TLS tunnel, may be applied for the transfer. Additionally or alternatively, the subsequent retrieval of the access code from the server arrangement 110 by the second apparatus 104 may be preceded by the server arrangement 110 authenticating the second apparatus 104 and/or the second user U2 before proceeding to delivery of the access code. Consequently, the method 200 may proceed to delivery of the access code in response to successful authentication of the second apparatus 104 and/or the second user U2, whereas the method 200 may not proceed to delivery of the access code in response to unsuccessful authentication. The authentication may be carried out using an authentication mechanism known in the art, e.g. one based on a username and a password, one based on biometric data, one based on multi-factor authentication, etc.

In some examples, the access code may be manually entered (e.g. typed) via the UI provided in the second apparatus 104 for inclusion in the access request transmitted to the target system 120. This approach may be applicable e.g. in scenarios where the second user U2 of the second apparatus 104 receives the access code from the first user U1 of the first apparatus 102, which may have received the access code from the server arrangement 110. In other examples, the access code may be readily available in a digital form at the second apparatus 104 and the access code may be provided for inclusion in the access request without the need for manual input via the UI of the second apparatus 104. This approach may be applicable e.g. in scenarios where the second apparatus 104 retrieves the access code from the server arrangement 110.

The size of the access code (as the number of bytes) may depend on the cryptographic hash function applied for its derivation. As an example in this regard, application of the SHA-256 as the cryptographic hash function results in the access code having size of 32 bytes. In some examples, the access code may be truncated to a shorter length for improved user experience especially in scenarios where manual entry of the access code via the UI of the second apparatus 104 is applied without substantially compromising the security of the system 100. The truncation may be carried out in the server arrangement 110 before transferring the access code to the first apparatus 102 and/or to the second apparatus 104 for use in subsequent access to the target system 120. As an example of such truncation, the 32-byte access code derived in the server arrangement 110 may be converted into a truncated access code that includes only the last 16 characters of the access code derived in the server arrangement 110 or it may be converted even to a PIN code of 6 to 8 digits. In case of truncation of the access code, a similar truncation is applied in the target system 120 before verification of the (truncated) access code received in the access request.

In scenarios where the access request is transferred from the second apparatus 104 to the target system 120 over a communication link or via a communication network, the access request or at least the access code included therein may be transferred via a secure connection between the second apparatus 104 and the target system 120, where a security mechanism known in the art, such as a TLS tunnel, may be applied for the data transfer to the target system 120. In another example, the second apparatus 104 may prove possession of the access code to the target system 120 via setting up a secure communication channel using a cryptographic protocol known in the art, such as the pre-shared key mode of TLS authentication (TLS-PSK), where the access code serves as the PSK.

### About a Metadata-Based Approach

While the examples described in the foregoing refer to application of the cryptographic procedure in general in determination of the access code (cf. block 204) and in verification of the access code (cf. block 208), in some examples the predefined cryptographic procedure may involve carrying out the determination of the access code and the verification of the access code on respective data blocks that are at least partially defined upon determining and verifying the access code. Such a procedure may involve the following:
the access code request may comprise additional code request data and the access request further comprises additional access request data, each comprising respective one or more information elements that further characterize the requested access;
determination of the access code may comprise applying the predefined cryptographic procedure on a data block that includes the one or more information elements of the additional code request data received in the access code request; and
verification of the access code may comprise applying the predefined cryptographic procedure on a verification data block that includes the one or more information elements of the additional access request data received in the access request.

Herein, the additional code request data may be also referred to as code request metadata and the additional access request data may be also referred to as access request metadata. The usage and certain characteristics of the additional code request data and the additional access request data for derivation and usage of the access code are described in further detail via examples provided in the following.

In particular, in the framework of the first embodiment, determining the access code via usage of the predefined cryptographic procedure may comprise deriving the access code using the HMAC with the predefined cryptographic hash function and the predefined secret key on a data block that includes the one or more information elements of the additional code request data, whereas verification of the access code via usage of the predefined cryptographic procedure may comprise verifying the access code using the HMAC with the predefined cryptographic hash function and the predefined secret key on a verification data block that includes the one or more information elements of the additional access request data.

In the access control that partially relies on the additional code request data and additional access request data, the one or more information elements of the additional access request data, respectively, correspond to the one or more information elements of the additional code request data. In other words, the additional code request data and the additional access request data convey information concerning the same characteristics of the requested access and their information content needs to be the same to enable successful verification of the access code at the target system 120. The information elements of the additional access request data are arranged into the verification data block in the target system 120 in the same order and in the same manner as the information elements of the additional code request data are arranged into the data block in the server arrangement 110 to facilitate verification that is based on a verification data block that is identical to the data block applied as basis for determining the corresponding access code.

According to various examples, the information elements included in the additional code request data and the corresponding one or more information elements included in the additional access request data may include one or more of the information elements described in the foregoing in context of the example that pertains to determination of admissibility of the access code request. As specific non-limiting examples in this regard, one of the following combinations of information elements may be applied:
at least one device ID,
at least one user ID,
at least one device ID and at least one user ID,
at least one device ID and a least one portion ID,
at least one user ID and at least one portion ID,
at least one device ID, at least one user ID and at least one portion ID.

In various examples in this regard, the at least one device ID may include the first device ID assigned to the first device 102 and/or the second device ID assigned to the second device 104, the at least one user ID may include the first user ID assigned to the first user U1 and/or the second user ID assigned to the second user U1, and the at least one portion ID may indicate the portion of the target system 120 for which the access is requested.

Still referring to the example that involves usage of the additional code request data and the additional access request data, in some examples, each of the data block applied in derivation of the access code in the server arrangement 110 and the verification data block applied in verification of the access code in the target system 120 may comprise one or more further data elements that are not included in the additional code request data and/or in the additional access request data, where the one or more further data elements are arranged into the verification data block in the target system 120 in the same order and in the same manner as they are arranged into the data block in the server arrangement 110. Moreover, the arrangement of the one or more further data elements of the verification data block in relation to the (other) information elements of the verification data block (in the target system 120) is the same as the arrangement of the one or more further data elements of the data block in relation to the (other) information elements of the data block (in the server arrangement 110).

In some examples, the one or more further data elements of the data block and the verification data block may comprise the target system ID, which is included in the access code request received at the server arrangement 110 (cf. block 202) and that is typically implicitly known at the target system 120.

In some examples, determination of the access code in the server arrangement 110 (cf. block 204) may comprise deriving or setting an expiry time indicator (e.g. via operation of the code generator portion 112) and applying the expiry time indicator as a further data element of the data block in the server arrangement 110. Moreover, the expiry time indicator may be included in the access request (cf. block 206) as part of the additional access request data to make it available for verification of the access code in the target system 120 and the expiry time indicator may be applied as a further data element of the verification data block in the target system 120. The expiry time indicator may serve to indicate an expiry time of the access code following its first (successful) verification in the target system (120) and the target system 120 (e.g. the access control portion 122) may control access to the target system 120 via usage of the respective access code accordingly. In other words, the expiry time indicator serves to indicate a duration of a validity period of the access code following its first (successful) verification in the target system 120. According to an example, the expiry time may be the same for all portions of the target system 120, whereas according to another example the expiry time may vary from one portion of the target system 120 to another. In both examples, the expiry time may be a predefined value chosen from a range from a few minutes to several days, depending e.g. on requirements arising from characteristics of the underlying target system 120 in general and/or on requirements arising from characteristics of the portion of the target system 120 under consideration. The expiry time indicator may indicate the expiry time, for example, as a number of seconds.

In some examples, determination of the access code in the server arrangement 110 (cf. block 204) may comprise deriving or setting a first validity period indicator based on a time of determining the access code and wherein derivation of the verification access code in the target system (cf. block 208) may comprise deriving or setting a second validity period indicator based on a time of deriving the verification access code. The first validity period indicator may be applied as a further data element of the data block in the server arrangement 110, whereas the second validity period indicator may be applied as a further data element of the verification data block in the target system 120. In this regard, the first validity period indicator may identify a time slot among a sequence of time slots of predefined duration within which the access code is derived, whereas the second validity period indicator may identify a time slot among the sequence of time slots of predefined duration within which the verification access code is derived. In various examples, the sequence of time slots may comprise hours of a day, days of a week, days of a month, weeks of a year, etc. and hence each of the first and second validity period indicators may indicate the respective hour of a day, the day of a week, the day of a month, the week of a year within which the respective one of the first and second validity periods indicators is derived.

Since each of the first and second validity period indicators are derived locally at the respective one of the server arrangement 110 and the target system 120 based on information of time and date available therein, there is no need to include information that defines the first validity period in the access code request sent to the server arrangement 110 or to include the information that defines the second validity period in the access request sent to the target system 120. Moreover, since the first validity period indicator is included in the data block serving as basis for determining the access code and the second validity period indicator is included in the verification data block serving as basis for verification of the access code, the verification of the access code is successful only when the two are derived within the same time slot of the predefined sequence of time slots and, consequently, time-limited access to the target system 120 is provided automatically via the verification of the received access code.

Still referring to the example that involves usage of the additional code request data and the additional access request data, those information elements of the additional access request data (i.e. the access request metadata) that are not readily known by the second apparatus 104 and/or by the second user U2 may be delivered to the second apparatus 104 and/or to the second user U2 for inclusion in the access request to be transmitted to the target system 120. In this regard, the information elements that are descriptive of identity of the second apparatus 104 (e.g. the second device ID) and/or identity of the second user U2 (e.g. the second user ID) are typically readily available to the second apparatus 104 and/or to the second user U2, whereas the remaining information elements of the additional access request may be transferred to the second apparatus 104, for example, using the approach described in the foregoing for transfer of the access code to the second apparatus 104 and/or to the second user U2, mutatis mutandis.

In some examples, the information elements of the additional access request data are manually entered (e.g. typed) via the UI provided in the second apparatus 104 for inclusion in the access request, whereas in other examples the information elements of the additional access request data may be readily available in a digital form at the second apparatus 104 and they may be provided for inclusion in the access request without the need for manual input via the UI provided in the second apparatus 104. The latter approach may be available especially in scenarios where the second apparatus 104 has retrieved the information elements under consideration from the server arrangement 110. In further examples, some of the information elements involved may be manually entered for inclusion in the access request, whereas the remaining ones are provided for inclusion in the access request in a digital form.

In scenarios where the access request is transferred from the second apparatus 104 to the target system 120 over a communication link or via a communication network, the additional access request data may be transferred together with the access code via a secure connection established between these two entities using a security mechanism known in the art, such as a TLS tunnel. Alternatively, the additional access request data may be transferred to the target system 120 separately from the access code without application of the security mechanism.

The examples provided in the foregoing, implicitly, assume that the access code request transmitted to the server arrangement 110 constitutes a request for a single access code. In other examples, the access code request may serve as a request for a plurality of access codes and, consequently, the server arrangement 110 may determine a plurality of access codes according to the procedure(s) described in the foregoing. In this regard, in an example, the access code request may imply a request for a predefined number of access codes different from one, e.g. two, three, four, etc., whereas in another example in this regard the access code request may further comprise an indication of a requested number of access codes.

In some examples, the access codes determined by the server arrangement 110 may be applicable for accessing the target system 120 (only) in a predefined order, e.g. in the same order they are determined in the target system 110. Such an approach facilitates the usage scenario described in the foregoing, where two parts of an operation pertaining to the target system 120 (e.g. software update) are to be carried out by two users in a predefined order.

Referring now to the second embodiment, along the lines described in the foregoing, determination of the access code may comprise determination of the access code via application of the predefined cryptographic hash function with the first predefined secret data available in the server arrangement 110, whereas verification of the access code may comprise application of the predefined cryptographic hash function with the second predefined secret data available in the target system 120, where the second predefined secret data corresponds to the first predefined secret data but it is not necessarily identical to the first predefined secret data.

According to an example, the first predefined secret data available in the server arrangement 110 may comprise a predefined hash chain derived via successive application of predefined cryptographic hash function on a piece of data, whereas the second predefined secret data available in the target system 120 involves a single hash that is a certain one of the hashes of the hash chain stored in the server arrangement 110. Hence the second predefined secret data corresponds to the first predefined secret data via the second predefined secret data being a predefined element of the first predefined secret data.

In this regard, the hash chain applied as the first predefined secret data may include a hash chain of N hashes H_{N}, H_{N-1}, H_{N-2}, . . . , H₁, where the N hashes are defined as H₁=H(seed), H₂=H(H₁), H₃=H(H₂), . . . , H_{N}=H(H_{N-1}) and where H( ) denotes the predefined cryptographic hash function. Initially, the second predefined secret data may include the first hash of the hash chain, i.e. H_{N}, whereas the first access code determined at the server arrangement 110 may be the second hash of the hash chain, i.e. H_{N-1}. Each time a new access code is requested, the server arrangement 110 adopts the next hash in the hash chain as the access code, whereas after each successful verification of the access code the target system 120 adopts the most recently received access code as the updated second predefined secret data to be applied for verification of the subsequent access code. Consequently, verifying the access code at the target system 120 may comprise applying the predefined cryptographic hash function to the access code received in the access request (e.g. the hash Hₖ of the hash chain) to derive a verification access code and comparing the verification access code so derived to the current second predefined secret data (e.g. the hash Hₖ+1 of the hash chain). The verification is successful in case these two values are identical to each other and the verification is unsuccessful otherwise.

Still referring to the second embodiment, aspects other than derivation of the access code in the server arrangement 110 and verification of the access code in the target system 120 may be provided in a similar manner as in the first embodiment, mutatis mutandis. As particular but non-limiting examples in this regard, the predefined cryptographic hash function applied in the second embodiment may be similar to that described in the foregoing to the first embodiment and the secure storage of the first predefined secret data in the server arrangement 110 and the secure storage of the second predefined secret data in the target system 120 may be provided as described above for the first embodiment.

The second embodiment may also make use of the code request metadata and the access request metadata described in the foregoing in context of the first embodiment. In this regard, each of the additional code request data serving as the code request metadata and the additional access request data serving as the access request metadata may be conveyed, respectively, in the access code request and in the access request as described in the foregoing for the first embodiment.

The usage of the additional code request data together with the first predefined secret data available in the server arrangement 110 for determination of the access code using may comprise concatenating the next hash in the hash chain alongside the output of applying the HMAC with the predefined cryptographic hash function and the next hash in the hash chain as the predefined secret key on the data block that includes the one or more information elements of the additional code request data. The usage of the additional access request data together with the second predefined secret data available in the target system 120 for verification of the access code using may comprise applying the predefined cryptographic hash function to first part of the access code (containing the next hash of the hash chain) and comparing to the current second predefined secret data, followed by, verifying the second part of the access code using the HMAC with the predefined cryptographic hash function and the first part of the access code as the predefined secret key on a verification data block that includes the one or more information elements of the additional access request data.

Referring now to the third embodiment, along the lines described in the foregoing, determination of the access code in the server arrangement 110 may comprise deriving the access code via application of the predefined AEAD function with the predefined secret key, whereas verification of the access code in the target system 120 may comprise applying the predefined AEAD function with the predefined secret key. The predefined AEAD function may comprise an authenticated encryption scheme known in the art, such as the advanced encryption standard Galois-counter mode (AES-CGM).

In a particular example in the framework of the third embodiment, determining the access code may comprise using the predefined AEAD function in encrypt mode with the predefined secret key on a data block that includes the one or more information elements of the additional code request data. Verifying the access code at the target system 120 may comprise applying the predefined AEAD function in decrypt mode with the predefined secret key on a data block that includes the one or more information elements of the additional access request. The AEAD function allows some data to only have integrity protection without encryption and decryption. Consequently, in some examples, the above-described approach for determining and verifying the access code may be modified such that some information elements of the additional code request and the corresponding information elements of the access request are passed as additional authenticated data (AAD) to the AEAD encrypt and decrypt function modes, respectively.

In another example in the framework of the third embodiment, determination of the access code may comprise using the predefined AEAD function in encrypt mode with the predefined secret key on a data block that includes common data which changes with every access request and which is known to both the server arrangement 110 and the target system 120. Consequently, verification of the access code at the target system 120 may comprise applying the predefined AEAD function in decrypt mode with the predefined secret key on a data block that includes the same common data known to both the server arrangement 110 and the target system 120. As an example in this regard, the common data may include a sequence number that is incremented by the same amount after each access code request in the server arrangement 110 and after each successful verification in the target system 120.

Still referring to the third embodiment, aspects other than derivation of the access code in the server arrangement 110 and verification of the access code in the target system 120 may be provided in a similar manner as in the first embodiment, mutatis mutandis. As particular but non-limiting examples in this regard, the respective secure storage of the predefined secret key and the possible change of the secure key may be provided as described above for the first embodiment.

Referring now to the fourth embodiment, along the lines described in the foregoing, determination of the access code in the server arrangement 110 may comprise applying a digital signature with predefined private key, whereas verification of the access code in the target system 120 may comprise verifying the digital signature with a predefined public key that corresponds to the predefined private key applied in derivation of the access code. The digital signature applied herein may comprise a digital signature derived via usage of a digital signature scheme known in the art, such as the elliptic curve digital signature algorithm (ECDSA).

In a particular example in the framework of the fourth embodiment, determination of the access code may comprise using the predefined cryptographic hash function on a data block that includes the one or more information elements of the additional code request data and passing the output of the hash function together with the predefined private key to a signature generation function. Verification of the access code at the target system 120 may comprise applying the predefined cryptographic hash function on a data block that includes the one or more information elements of the additional access request data and passing the output of the hash function together with the predefined public key and the access code containing the signature to a signature verification function before finally asserting that the verification function returns an affirmative value.

In another example in the framework of the fourth embodiment, determination of the access code may comprise using the predefined cryptographic hash function on a data block that includes common data which changes with every access request and which is known to both the server arrangement 110 and the target system 120 and passing the output of the hash function together with the predefined private key to a signature generation function. Verification of the access code at the target system 120 may comprise applying the predefined cryptographic hash function on a data block that includes the same common data known to both the server arrangement 110 and the target system 120 and passing the output of the hash function together with the predefined public key and the access code containing the signature to a signature verification function before finally asserting that the verification function returns an affirmative value. As an example in this regard, the common data may include a sequence number that is incremented by the same amount after each access code request in the server arrangement 110 and after each successful verification in the target system 120.

Still referring to the fourth embodiment, aspects other than derivation of the access code in the server arrangement 110 and verification of the access code in the target system 120 may be provided in a similar manner as in the first embodiment, mutatis mutandis. As particular but non-limiting examples in this regard, the secure storage of the predefined private key in the server arrangement 110 may be provided as described above for the first embodiment.

The access control system or identification system according to the present disclosure provided via operation of the code generator portion 112 of the server arrangement 110 and the access control portion of the target system 120 provides e.g. the following advantages over various solutions known in the art:

The access control approach according to the present disclosure does not require network connectivity in verifying the access codes and/or other access information, which contributes towards improved security and simplified design over many previously known approaches.

The access control approach according to the present disclosure is flexible in terms of being able to provide a desired number of access codes that provide access to desired portions of the target system 120, either in parallel or in desired sequence.

The access control approach according to the present disclosure is flexible also in terms of not being bound to any specific manner of transferring the access codes and/or other access information between the apparatuses involved in the procedure.

The access control approaches at least according to the first, second and third embodiments described in the foregoing rely on relatively straightforward cryptographic operations that are widely supported in standard hardware components that are applicable for implementing the disclosed approach. Consequently, the computational load imposed by these approaches is significantly lower than e.g. that required for commonly applied approaches that rely on asymmetric/public-key cryptography.

The access control approaches at least according to the first, second and third embodiments described in the foregoing provide improved resilience against a threat posed by quantum computers for conventional public-key cryptographic schemes such as the RSA.

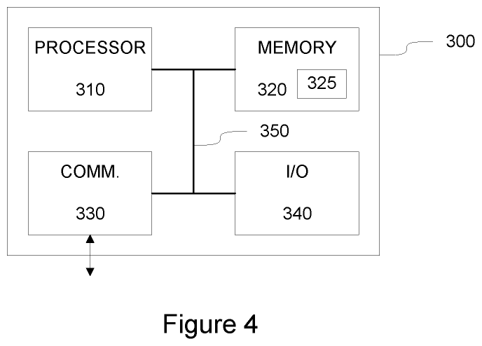

Along the lines described in the foregoing, each of the first apparatus 102, the second apparatus 104, the code generator portion 112 of the server arrangement 110 and the access control portion 122 of the target system 120 may comprise or may be provided using a computer apparatus comprising one or more processors and one or more memories storing one or more computer programs, where the one or more processors are arranged to execute one or more computer programs to make the computer apparatus serve as the respective one of the first apparatus 102, the second apparatus 104, the code generator portion 112 and the access control portion 122. As an example in this regard, FIG. 4 illustrates a block diagram of some components of an apparatus 300 that may be employed to implement the respective one of the first apparatus 102, the second apparatus 104, the code generator portion 112 and the access control portion 122.

The apparatus 300 comprises a processor 310 and a memory 320. The memory 320 may store data and computer program code 325. The apparatus 300 may further comprise communication means 330 for wired or wireless communication with other apparatuses and/or user I/O (input/output) components 340 that may be arranged, together with the processor 310 and a portion of the computer program code 325, to provide a user interface for receiving input from a user and/or providing output to the user. In particular, the user I/O components may include user input means, such as one or more keys or buttons, a keyboard, a touchscreen or a touchpad, etc. The user I/O components may include output means, such as a display or a touchscreen. The components of the apparatus 300 are communicatively coupled to each other via a bus 350 that enables transfer of data and control information between the components.

The memory 320 and a portion of the computer program code 325 stored therein may be further arranged, with the processor 310, to cause the apparatus 300 to perform at least some aspects of operation of the respective one of the first apparatus 102, the second apparatus 104, the code generator portion 112 and the access control portion 122. The processor 310 is configured to read from and write to the memory 320. Although the processor 310 is depicted as a respective single component, it may be implemented as respective one or more separate processing components. Similarly, although the memory 320 is depicted as a respective single component, it may be implemented as respective one or more separate components, some or all of which may be integrated/removable and/or may provide permanent/semi-permanent/dynamic/cached storage.

The computer program code 325 may comprise computer-executable instructions that implement at least some aspects of operation of the respective one of the first apparatus 102, the second apparatus 104, the code generator portion 112 and the access control portion 122 when loaded into the processor 310. As an example, the computer program code 325 may include a computer program consisting of one or more sequences of one or more instructions. The processor 310 is able to load and execute the computer program by reading the one or more sequences of one or more instructions included therein from the memory 320. The one or more sequences of one or more instructions may be configured to, when executed by the processor 310, cause the apparatus 300 to perform at least some aspects of operation of the respective one of the first apparatus 102, the second apparatus 104, the code generator portion 112 and the access control portion 122. Hence, the apparatus 300 may comprise at least one processor 310 and at least one memory 320 including the computer program code 325 for one or more programs, the at least one memory 320 and the computer program code 325 configured to, with the at least one processor 310, cause the apparatus 300 to perform at least some aspects of operation of the respective one of the first apparatus 102, the second apparatus 104, the code generator portion 112 and the access control portion 122.

The computer program code 325 may be provided e.g. a computer program product comprising at least one computer-readable non-transitory medium having the computer program code 325 stored thereon, which computer program code 325, when executed by the processor 310 causes the apparatus 300 to perform at least some aspects of operation of the respective one of the first apparatus 102, the second apparatus 104, the code generator portion 112 and the access control portion 122. The computer-readable non-transitory medium may comprise a memory device, a record medium or another article of manufacture that tangibly embodies the computer program. As another example, the computer program may be provided as a signal configured to reliably transfer the computer program.

Reference(s) to a processor herein should not be understood to encompass only programmable processors, but also dedicated circuits such as field-programmable gate arrays (FPGA), application specific circuits (ASIC), signal processors, etc.

1-48. (canceled)

49. A method for controlling access to a target system, the method comprising:
transmitting, to a server arrangement from a first apparatus, an access code request to provide an access code for accessing at least a portion of the target system, wherein the access code request is associated with the target system;
receiving, at the server arrangement, the access code
request;
determining, at the server arrangement in response to said access code request, the access code via usage of a predefined cryptographic procedure based at least on information stored at the server arrangement;
transmitting said access code from the server arrangement to the first apparatus;
delivering the access code from the first apparatus to the second apparatus;
transmitting, from the second apparatus to the target system,
an access request for accessing the target system, wherein the access request comprises said access code received from the first apparatus;
receiving, at the target system, the access request for accessing the target system;
verifying, at the target system in response to said access request, the access code included in said access request via usage of said predefined cryptographic procedure based at least on information
stored at the target system, which information corresponds to said information stored at the server arrangement; and
granting, by the target system, access to said at least portion of the target system based on successful verification of the access
code received in the access request.

50. A method according to claim 49,
wherein the access code request comprises additional code request data comprising one or more information elements that further characterize the requested access, and
wherein said determining comprises determining, based on the target system identifier and on information elements included in the additional code request data, whether the access code request is admissible and proceeding to derivation of the access code in response
to finding the access code request admissible.

51. A method according to claim 50, wherein said additional code request data comprises one or more of the following information elements:
a device identifier assigned to an apparatus requesting the access code for accessing the target system,
a user identifier assigned to a user requesting the access code for accessing the target system,
a device identifier assigned to an apparatus for which the access to the target system is requested,
a user identifier assigned to a user for which the access to the target system is requested,
a portion identifier that, together with the target system identifier, identifies a portion of the target system to which the access is requested.

52. A method according to claim 49,
wherein the access code request comprises additional code request data and the access request further comprises additional access request data, each comprising respective one or more information elements that further characterize the requested access,
wherein determining the access code comprises applying the predefined cryptographic procedure on a data block that includes the one or more information elements of the additional code request data received in the access code request,
wherein verifying the access code comprises applying said
predefined cryptographic procedure on a verification data block that includes the one or more information elements of the additional access request data received in the access request.

53. A method according to claim 52, wherein the one or more information elements of the additional access request data respectively correspond to the one or more information elements of the additional code request data.

54. A method according to claim 53, wherein determining the
access code further comprises deriving an expiry time indicator that indicates an expiry time of the access code following its first verification in the target system,
wherein the additional access request data comprises the expiry time indicator, and
wherein said one or more further data elements included in the data block and in the verification data block comprise the expiry time indicator.

55. A method according to claim 49, wherein granting access comprises granting access to said at least portion of the target system in response to successful verification of the access code received in the access request, and wherein granting access to said
at least portion of the target system is further conditional to at least one of the following requirements:
reception of the access request within one of one or more predefined time windows, current operational state of the target system being one of one or
more predefined operational states.

56. A method according to claim 49, further comprising:
receiving, at the first apparatus from the second apparatus, a preliminary request to access the target system;
verifying, at the first apparatus based on the preliminary request, admissibility of the second apparatus and/or a user of the second apparatus to access the target system; and
transmitting said access code request from the first apparatus to the server arrangement in response to finding the preliminary
request admissible.

57. A method according to claim 49, wherein the access code is delivered from the first apparatus to the second apparatus
using one of the following:
via an information exchange carried out under control of respective users of the first and second apparatuses,
via usage of a predefined protocol for delivering the access code from the first apparatus to the second apparatus.

58. A system comprising:
a first apparatus;
a second apparatus,
a server arrangement, and a target system;
wherein:
the first apparatus configured to:
transmit, to the server arrangement, an access code request to provide an access code for accessing at least a portion of the target system, wherein the access code request is associated with the target system, and
deliver the access code to the second apparatus; and the second apparatus configured to:
receive the access code from the first apparatus, and
transmit an access request for accessing the target system, wherein the access request comprises said access code received
from the first apparatus;
the server arrangement configured to:
receive the access code request, and
determine, in response to said access code request, the access code via usage of a predefined cryptographic procedure based at least on information stored at the server arrangement,
transmit said access code to the first apparatus; and the target system configured to:
receive an access request for accessing the target system, wherein the access request comprises said access code determined at the server arrangement,
verify, in response to said access request, the access code included in said access request via usage of said predefined cryptographic procedure based at least on information stored at the target system, which information corresponds to said information stored at the server arrangement, and
grant access to said at least portion of the target system based on successful verification of the access code received in the access request.

59. A system according to claim 58, wherein the target system
comprises a control system for controlling at least some aspects of a passenger conveyor system.

60. A system according to claim 59, wherein the passenger conveyor system comprises an elevator system or an escalator system.

61. A method according to claim 50,
wherein the access code request comprises additional code request data and the access request further comprises additional access request data, each comprising respective one or more information elements that further characterize the requested access,
wherein determining the access code comprises applying the predefined cryptographic procedure on a data block that includes the one or more information elements of the additional code request data received in the access code request,
wherein verifying the access code comprises applying said predefined cryptographic procedure on a verification data block that includes the one or more information elements of the additional access request data received in the access request.

62. A method according to claim 51,
wherein the access code request comprises additional code request data and the access request further comprises additional access request data, each comprising respective one or more information elements that further characterize the requested access,
wherein determining the access code comprises applying the predefined cryptographic procedure on a data block that includes the one or more information elements of the additional code request data received in the access code request,
wherein verifying the access code comprises applying said
predefined cryptographic procedure on a verification data block that includes the one or more information elements of the additional access request data received in the access request.

63. A method according to claim 50, wherein granting access comprises granting access to said at least portion of the target system in response to successful verification of the access code received in the access request, and wherein granting access to said
at least portion of the target system is further conditional to at least one of the following requirements:
reception of the access request within one of one or more predefined time windows, current operational state of the target system being one of one or
more predefined operational states.

64. A method according to claim 51, wherein granting access comprises granting access to said at least portion of the target system in response to successful verification of the access code received in the access request, and wherein granting access to said
at least portion of the target system is further conditional to at least one of the following requirements:
reception of the access request within one of one or more predefined time windows, current operational state of the target system being one of one or
more predefined operational states.

65. A method according to claim 52, wherein granting access comprises granting access to said at least portion of the target system in response to successful verification of the access code received in the access request, and wherein granting access to said
at least portion of the target system is further conditional to at least one of the following requirements:
reception of the access request within one of one or more predefined time windows, current operational state of the target system being one of one or
more predefined operational states.

66. A method according to claim 53, wherein granting access comprises granting access to said at least portion of the target system in response to successful verification of the access code received in the access request, and wherein granting access to said
at least portion of the target system is further conditional to at least one of the following requirements:
reception of the access request within one of one or more predefined time windows, current operational state of the target system being one of one or
more predefined operational states.

67. A method according to claim 54, wherein granting access comprises granting access to said at least portion of the target system in response to successful verification of the access code received in the access request, and wherein granting access to said
at least portion of the target system is further conditional to at least one of the following requirements:
reception of the access request within one of one or more predefined time windows, current operational state of the target system being one of one or
more predefined operational states.

68. A method according to claim 50, further comprising:
receiving, at the first apparatus from the second apparatus, a preliminary request to access the target system;
verifying, at the first apparatus based on the preliminary request, admissibility of the second apparatus and/or a user of the second apparatus to access the target system; and
transmitting said access code request from the first apparatus to the server arrangement in response to finding the preliminary
request admissible.
